(19) United States
(12) Patent Application Publication
(10) Pub. No.: US 2025/0187633 A1
(43) Pub. Date: Jun. 12, 2025

(54) SYSTEM AND METHOD FOR AUTONOMOUS TRAILER INTEGRATION

(71) Applicant: VOLVO TRUCK CORPORATION, Göteborg (SE)

(72) Inventor: Chad BURCHETT, Browns Summit, NC (US)

(73) Assignee: VOLVO TRUCK CORPORATION, Göteborg (SE)

(21) Appl. No.: 18/844,793

(22) PCT Filed: Mar. 7, 2022
(86) PCT No.: PCT/US2022/019160

§ 371 Date: Sep. 6, 2024

(51) Int. Cl. B60W 60/00; B60W 10/18; B60W 10/22; B60W 30/182

(52) U.S. Cl. CPC B60W 60/00184; B60W 10/18; B60W 10/22; B60W 30/182; B60W 2300/14; B60W 2422/95; B60W 2530/205; B60W 2555/20

(57) ABSTRACT

Systems, methods, and articulated vehicles which use sensor rails attached to trailers to provide improved control for autonomous articulated vehicles. An example vehicle can receive, at a computer system of a tractor operating in an autonomous mode, trailer sensor data from a plurality of trailer sensors located on at least one trailer, the at least one trailer being coupled to the tractor. The computer system can also receive road condition data from at least one sensor, the at least one sensor being located on at least one of the tractor and the at least one trailer. The computer system can then identify, based on the trailer sensor data and the road condition data, a physical condition of the at least one trailer to be modified, and modify, via an electrical signal transmitted from the computer system, the physical condition.

### BACKGROUND

### 1. Technical Field

The present disclosure relates to a trailer for articulated vehicles, and more specifically to sensors for a trailer and which provide data to an autonomous tractor such that the tractor can operate the articulated vehicle safely.

### 2. Introduction

The trucking industry relies on the use of articulated vehicles, which have a permanent or semi-permanent pivot joint, allowing the vehicle to make turns more sharply. These articulated vehicles often rely on a tractor (the front part which pulls) and one or more rear parts (the trailer).

Autonomous technology for articulated vehicles currently relies on an autonomous tractor pulling a conventional trailer. However, in such configurations the autonomous tractor does not have visibility of the trailer conditions. If, for example, a dangerous situation is occurring to the rear of the trailer, the autonomous tractor will be unable to react until the trailer is struck from the side or behind. As another example, if the trailer is sitting too high, the trailer may make contact with an overpass.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system of a tractor operating in an autonomous mode, trailer sensor data from a plurality of trailer sensors located on at least one trailer, the at least one trailer being coupled to the tractor; receiving, at the computer system, road condition data from at least one sensor, the at least one sensor being located on at least one of the tractor and the at least one trailer; identifying, via at least one processor of the computer system and based on the trailer sensor data and the road condition data, a physical condition of the at least one trailer to be modified; and modifying, via an electrical signal transmitted from the computer system, the physical condition.

A articulated vehicle configured to perform the concepts disclosed herein can include: a tractor operating in an autonomous mode; at least one trailer coupled to the tractor; at least one processor; and a non-transitory computer-readable storage medium having instructions stored which, when executed by the at least one processor, cause the at least one processor to perform operations comprising: receiving trailer sensor data from a plurality of trailer sensors located on the at least one trailer; receiving road condition data from at least one sensor, the at least one sensor being located on at least one of the tractor and the at least one trailer; identifying, based on the trailer sensor data and the road condition data, a physical condition of the at least one trailer to be modified; and modifying, via a transmitted electrical signal, the physical condition.

### ASPECTS OF THE DISCLOSURE

According to an aspect of the disclosure, a method comprises receiving, at a computer system of a tractor operating in an autonomous mode, trailer sensor data from a plurality of trailer sensors located on at least one trailer, the at least one trailer being coupled to the tractor; receiving, at the computer system, road condition data from at least one sensor, the at least one sensor being located on at least one of the tractor and the at least one trailer; identifying, via at least one processor of the computer system and based on the trailer sensor data and the road condition data, a physical condition of the at least one trailer to be modified; and modifying, via an electrical signal transmitted from the computer system, the physical condition.

According to an aspect of the disclosure, the plurality of trailer sensors are mounted to the at least one trailer using at least one sensor rail, where each sensor rail can be removably coupled to the at least one trailer.

According to an aspect of the disclosure, the method further comprises transmitting, from the computer system to a trailer sensor within the plurality of trailer sensors, a command to change location on a sensor rail within the at least one sensor rail.

According to an aspect of the disclosure, the at least one sensor rail is removably coupled to the at least one trailer in a vertical configuration, with a first end of the at least one sensor rail located directly above a second end of the at least one sensor rail.

According to an aspect of the disclosure, the at least one sensor rail is removably coupled to the at least one trailer in a horizontal configuration, with a first end of the at least one sensor rail located laterally to a second end of the at least one sensor rail.

According to an aspect of the disclosure, the modifying of the physical condition comprises at least one of: applying brake pressure to at least one wheel supporting the at least one trailer; modifying a steerable axle; raising or lowering trailer suspension; and adjusting ride height of an air bag on the at least one trailer.

According to an aspect of the disclosure, the tractor is configured to operate in both a manual mode and the autonomous mode.

According to an aspect of the disclosure, the receiving of the trailer sensor data, the receiving of the road condition data, the identifying of the physical condition, and the modifying of the physical condition occur while the tractor and the at least one trailer are in transit.

According to an aspect of the disclosure, the road conditions data indicates the at least one trailer will not clear an overpass without modifying trailer suspension of the at least one trailer.

According to an aspect of the disclosure, the road condition data comprises wind data for winds hitting the at least one trailer.

According to an aspect of the disclosure, articulated vehicle comprises a tractor operating in an autonomous mode; at least one trailer coupled to the tractor; at least one processor; and a non-transitory computer-readable storage medium having instructions stored which, when executed by the at least one processor, cause the at least one processor to perform operations comprising receiving trailer sensor data from a plurality of trailer sensors located on the at least one trailer; receiving road condition data from at least one sensor, the at least one sensor being located on at least one of the tractor and the at least one trailer; identifying, based on the trailer sensor data and the road condition data, a physical condition of the at least one trailer to be modified; and modifying, via a transmitted electrical signal, the physical condition.

According to an aspect of the disclosure, the plurality of trailer sensors are mounted to the at least one trailer using at least one sensor rail, where each sensor rail can be removably coupled to the at least one trailer.

According to an aspect of the disclosure, the non-transitory computer-readable storage medium having additional instructions stored which, when executed by the at least one processor, cause the at least one processor to perform additional operations comprising: transmitting, to a trailer sensor within the plurality of trailer sensors, a command to change location on a sensor rail within the at least one sensor rail.

According to an aspect of the disclosure, the at least one sensor rail is removably coupled to the at least one trailer in a vertical configuration, with a first end of the at least one sensor rail located directly above a second end of the at least one sensor rail.

According to an aspect of the disclosure, the at least one sensor rail is removably coupled to the at least one trailer in a horizontal configuration, with a first end of the at least one sensor rail located laterally to a second end of the at least one sensor rail.

According to an aspect of the disclosure, the modifying of the physical condition comprises at least one of: applying brake pressure to at least one wheel supporting the at least one trailer; modifying a steerable axle; raising or lowering trailer suspension; and adjusting ride height of an air bag on the at least one trailer.

According to an aspect of the disclosure, the tractor is configured to operate in both a manual mode and the autonomous mode.

According to an aspect of the disclosure, the receiving of the trailer sensor data, the receiving of the road condition data, the identifying of the physical condition, and the modifying of the physical condition occur while the tractor and the at least one trailer are in transit.

According to an aspect of the disclosure, the road conditions data indicates the at least one trailer will not clear an overpass without modifying trailer suspension of the at least one trailer.

According to an aspect of the disclosure, the road condition data comprises wind data for winds hitting the at least one trailer.

### BRIEF DESCRIPTION OF THE DRAWINGS

FIG. 1 illustrates an example of a tractor and a trailer;

FIG. 2 illustrates an example of a tractor with a trailer configured as disclosed herein;

FIG. 3 illustrates an example of a tractor pulling multiple trailers configured as disclosed herein;

FIG. 4 illustrates an example system diagram;

FIG. 5 illustrates an example method embodiment; and

FIG. 6 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Vehicles configured as disclosed herein allow a trailer or multiple trailers to be fully connected to an autonomous tractor, where the trailer(s) is equipped with an array of sensors to detect the position of the trailer, road conditions, surroundings, or other aspects of the trailer condition. That sensor data is sent to the tractor, thereby communicating the status of the trailer or trailers to the tractor and allowing the tractor to make adjustments if necessary. Sensor rails may be mounted to the sides of the trailer (horizontally and/or vertically), and sensors attached to or contained within the sensor rails may move along the rail system (e.g., forward and rearward, or upward and downward) to different locations along the sensor rail. The specific locations along the sensor rails where the sensors are deployed can depend, for example, on the configuration of the articulated vehicle and how the system choses to deploy the sensors in a given situation or circumstance. In some configurations, the sensors can be configured to move along the rails while in transit, such that if the computer system determines that a different sensor deployment configuration would provide better data for the system, the sensors can move mid-operation/transit, thereby providing desired information based on the control algorithms from the tractor and each trailer or trailers.

Preferably, the computer system analyzing the sensor data is within the tractor, but may also be within the trailer. The tractor is configured to operate in an autonomous mode, without human control as the vehicle is in transit. In some configurations, the tractor can be configured to operate in both an autonomous mode and a manual mode, whereas in other configurations the tractor may be configured to operate exclusively in the autonomous mode. In such an autonomous mode, the tractor (via a computer system) can control steering, braking, acceleration, and other control systems for the tractor. When coupled to one or more trailers, the computer system of the tractor can control aspects of the trailers, such as suspension, braking, air bags, etc., through the use of an electrical control system (wires, wireless or Bluetooth control signals, etc.). In some embodiments, the trailer may include the computer system for such control.

One example of how this will improve safe autonomous operation is an articulated, autonomous vehicle going down a straight road. In this example, the trailer sensors can detect how well the trailer is tracking in the lane. If the crown of the road is making the trailer or trailers sit unevenly, or causing the trailer track to the edge of the lane, the system may determine to either adjust the ride height on each of the air bags on the trailer or, if the trailer has steerable axles, the system may adjust the steering angle to center the trailer in the lanes.

As another example, if the trailer sensors detect cross winds having a strong effect on the trailer, the computer system within the tractor may decide to apply brake pressure at a given wheel end of the tractor and/or the trailer to try to control the direction of the trailer and maintain the trailer's position in the center of the lane it is travelling. Likewise, if the sensors of the trailer or trailers were to detect unstable movement of the trailer(s) within the lanes, the computer system can apply brake pressure to straighten out the load and keep the trailer centered within the lanes.

Yet another example of controls would be if the trailer sensors detected another vehicle quickly approaching from the rear in a manner which appears as if it could create a rear collision. In such a scenario, the trailer sensors could quickly alert the autonomous tractor to pull onto the shoulder, speed up, or move into an open lane without traffic to avoid a rear collision. In making that determination, the computer system can further rely on traffic data provided by the trailer sensors, the traffic data in this case providing information about vehicle positions (or lack thereof) in the lanes surrounding the trailer, as well as immediately behind the trailer, such that the sensors on the trailer can ensure there are no other objects before the lane change.

Another example control method is when an articulated vehicle enters a turn or a roundabout. In such a circumstance, the sensors of the trailer or trailers can actively track their trajectory with the goal to stay within the lanes. The trailer sensors can convey that information to the tractor computer system, which can initiate braking of wheel ends and/or steerable axles of the trailer(s) to navigate the turn or roundabout, without contacting objects in other lanes or in a manner which may interfere with the trajectory of the vehicle.

Yet another example would be when the vehicle sensors and/or otherwise determined road condition data indicate a ground clearance of an underpass, the computer system can compare that to the height of the trailer provided by trailer sensors. When the trailer is determined to exceed the height of the underpass, the computer system can actively lower the trailer's suspension to allow the articulated vehicle to pass.

The combination of tractor and trailers is theoretically unlimited as to how much propulsion power the tractor and each trailer can propel the load and within legal limits of the highway systems. Similarly, the number of trailers pulled by a given tractor may vary according to the needs of users or circumstances, such that an articulated vehicle configured as described herein may have a single trailer, two trailers, three trailers, or more, depending on specific needs.

The sensor rails can be configured such that they can removably couple to the trailers. This can use clamps, magnets, locks, or other mechanisms to secure the rails to the trailer. Preferably, the sensor rails connect to the corners of the trailer, such that the edge of the trailer has a sensor rail attached (whether a horizontal rail or a vertical rail). For example, the sensor rail can be horizontally attached to the top edges of a trailer and the bottom edges along the length of the trailer, or vertically at the four corners of the trailer. The sensor rails can be removed from the trailer after delivery, then installed in on a different trailer. In this manner, the sensor rails represent a modular addition which can be added or removed from trailers as needed. The sensor rails can be motorized, allowing for movement of the sensors according to a configuration provided by the computer system. Alternatively, the sensors themselves can be motorized (and the rail fixed), such that the individual sensors can relocate along the sensor rail according to the directions of the computer system.

The trailers disclosed herein can be configured with brakes (such as air brakes) which can engage with one or more tires of the trailer, steerable axles, air bags which can change the ride height of one side of the trailer (e.g., making the ride height shorter on one side and taller on the other side), etc. In some configurations, the trailer wheels can include electrified motors, allowing the trailers to provide propulsion power to the wheels and assist in straightening out the load. For example, if the trailer sensors include optical sensors, radar, LIDAR (Light Detection and Ranging), infrared cameras, range finders, and/or other types of sensors, the trailer can detect its surroundings. When the articulated vehicle needs to back into position (e.g., when loading or offloading cargo from the trailer), the trailer sensors can detect the surroundings, provide that information to the computer system, and the computer system can engage the trailer wheels to reverse the trailer in a proper manner. If the dock to which the trailer is approaching is at a different height than the trailer, the trailer sensor can detect the difference, send the information to the computer system, and the computer system can raise/lower the trailer ride height as needed (by modifying either the suspension and/or airbags of the trailer). Thus when the trailer connects to the dock, it is at the same height as the dock. Notably, without the trailer sensors reversing the trailer/articulated vehicle would be impossible.

Another exemplary type of sensor which can be included within the trailer sensors are sensors associated with the individual wheels of the trailer. These sensors can, for example, detect the speed of the trailer wheel, the amount of pressure being applied by the brakes, the tone of the anti-lock brake system (ABS) (e.g., an ABS tone ring sensor). There can also be ride height sensors, sensors which detect exhaust air from airbags, tire air pressure sensors, forward facing cameras which detect information regarding upcoming obstacles (such as underpasses), gyroscopes, etc.

FIG. 1 illustrates an example of a tractor 102 and a trailer 104. The trailer 104 is removably coupled to the tractor 102, meaning that while the trailer 104 and tractor 102 are coupled together during operation (usually via a kingpin), they can also be separated without harming or otherwise impairing the integrity of either the tractor 104 or trailer 104.

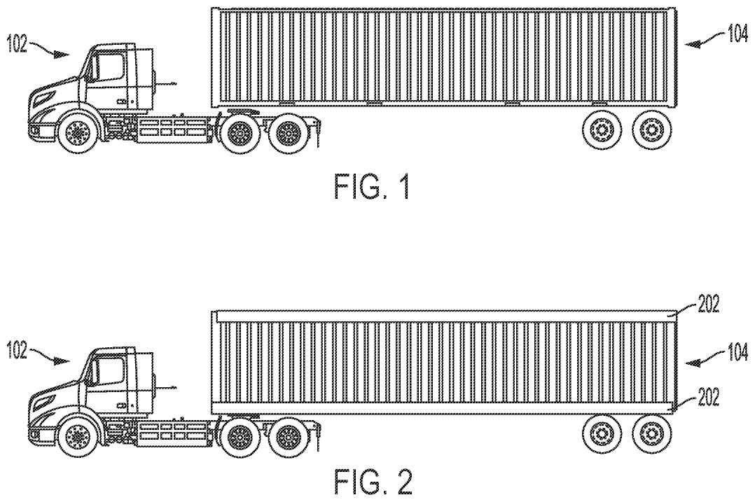

FIG. 2 illustrates an example of a tractor 102 with a trailer 104 configured with sensor rails 202 as disclosed herein. As illustrated, the sensor rails 202 are positioned horizontally along the length of the trailer 104. In other configurations, the sensor rails 202 could be coupled to the trailer 104 vertically at the corners of the trailer. For example, there could be two sensor rails vertically coupled to the rear corners of the trailer 104 and two additional sensor rails vertically coupled to the front corners (near the tractor 102) of the trailer 104. In yet other configurations, there can be the horizontal sensor rails 202 and vertical sensor rails on the trailer. As illustrated, there are sensor rails 202 on the top and bottom of the trailer 104, however in some configurations there may be only a single sensor rail 202 at the top or bottom of each side (i.e., left and right sides) of the trailer 104. Sensor rails 202 may also be coupled in the middle of the trailer 104, or at other locations along the trailer 104.

Sensors within the sensor rails 202 can be commanded by a computer system to move locations within the sensor rail 202. For example, the computer system may distribute the sensors in any manner needed along the length of the sensor rail 202. In some cases, the sensors may also be moved manually.

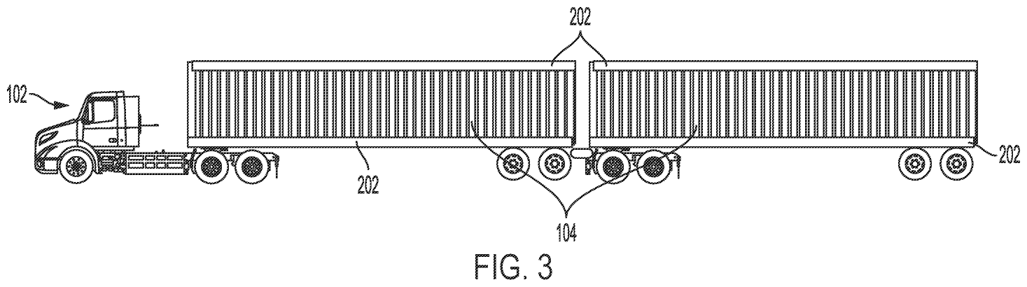

FIG. 3 illustrates an example of a tractor 104 pulling multiple trailers 104 with sensor rails 202 equipped on both trailers 104. In such cases, the sensor data from sensors in all of the sensor rails 202 is received by a computer system. Generally the computer system will be located in the tractor 102, though in some autonomous vehicles the computer system may be located in one of the trailers 104.

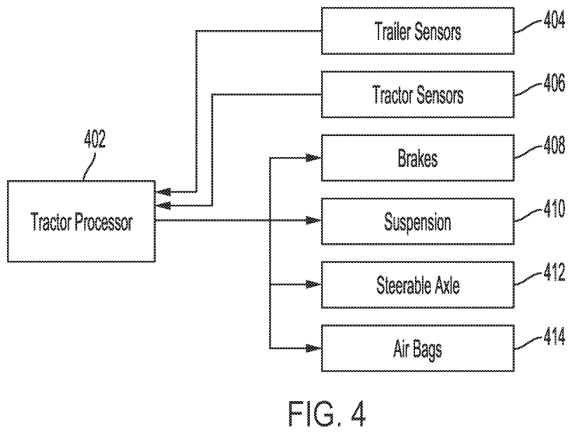

FIG. 4 illustrates an example system diagram for an articulated vehicle as described herein. As illustrated, there are trailer sensors 404, which can be contained in the sensor rails described herein. The trailer sensors 404 can provide trailer sensor data to a computer system located in the tractor, the tractor processor 402. The trailer sensors 404 can be any type of sensor needed, such as optical sensors, radar, LIDAR, range detectors, heat detectors, sound/audio sensors, sensors for detecting road conditions, sensors for detecting load distribution of the trailer, sensors for detecting pitch of a trailer, sensors for detecting wheel speed of trailer wheels, sensors for detecting pressure being applied to trailer brakes, sensors for detecting possible collisions with the trailer, sensors for detecting the height of the trailer, tire pressures of the trailer wheels, etc. The system also has tractor sensors 406 which provide data to the tractor processor 402. The tractor sensors 406 can, like the trailer sensors, detect road conditions, possible obstacles, tire pressures, speed of the articulated vehicle, etc.

As the trailer sensor data is received at the tractor processor 402 from the trailer sensors 404 and the tractor sensor 406, the tractor processor 402 (operating in an autonomous mode) can determine that changes need to be made to ensure the safe operation of the vehicle. To accomplish this, the tractor processor 402 transmits electrical signals to vehicle components in the tractor and/or trailer, such as brakes 408, suspension control 410, steerable axles 412, and air bags 414. Such components are exemplary only and are not exclusive.

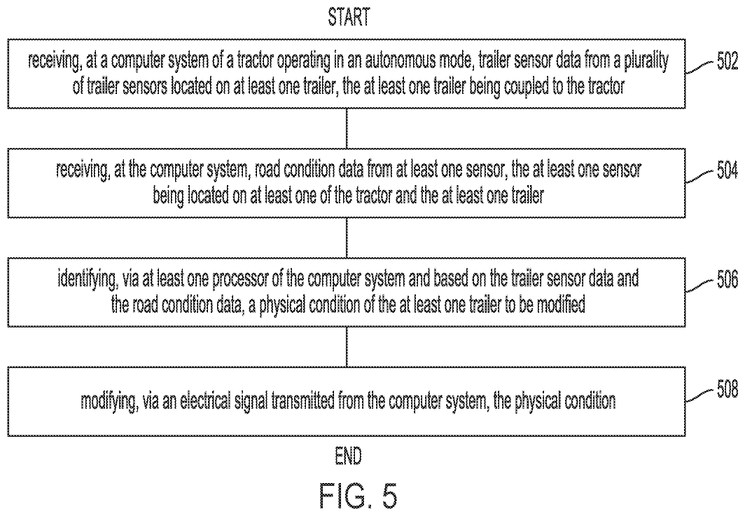

FIG. 5 illustrates an example method embodiment. As illustrated, the method can include receiving, at a computer system of a tractor operating in an autonomous mode, trailer sensor data from a plurality of trailer sensors located on at least one trailer, the at least one trailer being coupled to the tractor (502). Exemplary, non-limiting trailer sensor data can include information about the height of the trailer, the pitch of the trailer load, location of the trailer in a lane, location of vehicles or other objects near to the trailer, etc. The method continues by receiving, at the computer system, road condition data from at least one sensor, the at least one sensor being located on at least one of the tractor and the at least one trailer (504). Exemplary, non-limiting road condition data can include angle/camber of the road, known heights of underpasses, road materials (dirt, asphalt, cement, etc.), potholes, road/lane width, etc. The method continues by identifying, via at least one processor of the computer system and based on the trailer sensor data and the road condition data, a physical condition of the at least one trailer to be modified (506), and modifying, via an electrical signal transmitted from the computer system, the physical condition (508). Exemplary physical conditions which can be modified include trailer height, angle of steerable axles, brake activity, etc.

In some configurations, the plurality of trailer sensors are mounted to the at least one trailer using at least one sensor rail, where each sensor rail can be removably coupled to the at least one trailer. In such configurations, the illustrated method can further include transmitting, from the computer system to a trailer sensor within the plurality of trailer sensors, a command to change location on a sensor rail within the at least one sensor rail. If the at least one sensor rail can be removably coupled, the at least one sensor rail may be removably coupled to the at least one trailer in a vertical configuration, with a first end of the at least one sensor rail located directly above a second end of the at least one sensor rail. Likewise, if the at least one sensor rail can be removably coupled, the at least one sensor rail may be removably coupled to the at least one trailer in a horizontal configuration, with a first end of the at least one sensor rail located laterally to a second end of the at least one sensor rail. Coupling can occur through mechanical coupling (such as locks) or through magnetic or other coupling means.

In some configurations, the modifying of the physical condition includes at least one of: applying brake pressure to at least one wheel supporting the at least one trailer; modifying a steerable axle; raising or lowering trailer suspension; and adjusting ride height of an air bag on the at least one trailer.

In some configurations, the tractor is configured to operate in both a manual mode and the autonomous mode. That is, the tractor may be configured to be driven by a human being (the manual mode), either in person or remotely, but may also have an autonomous mode where the computer system pilots the vehicle (with or without a human being present).

In some configurations, the receiving of the trailer sensor data, the receiving of the road condition data, the identifying of the physical condition, and the modifying of the physical condition occur while the tractor and the at least one trailer are in transit. For example, the illustrated method can occur as the vehicle is driving down the highway. If the vehicle is approaching an underpass and detects, via the tractor processor using the trailer sensor data and/or the road condition data, that the trailer is too high for the underpass, the tractor processor can send a signal to the trailer suspension and/or trailer airbags to lower the overall height of the trailer—while the trailer continues down the road toward the underpass. After clearing the underpass the trailer height may be again adjusted as desired by the computer system.

In some configurations, the road conditions data can indicate the at least one trailer will not clear an overpass without modifying trailer suspension of the at least one trailer (e.g., lowering the suspension such that the trailer can pass under the overpass without contact).

In some configurations, the road condition data comprises wind data for winds hitting the at least one trailer. In such configurations, the computer system can modify how the tractor and/or trailer is driven to compensate for the winds (e.g., modify a steerable axle, modify airbags to have the trailer load tilt towards the wind, etc.).

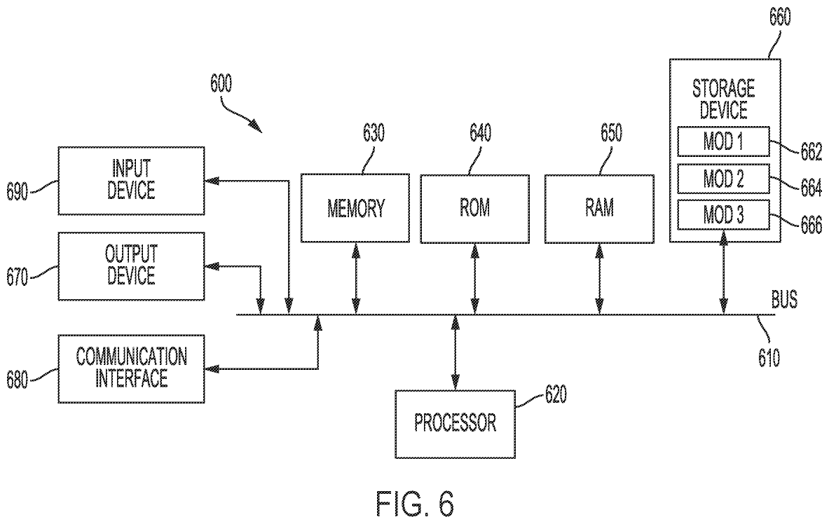

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 6 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a computer system of a tractor operating in an autonomous mode, trailer sensor data from a plurality of trailer sensors located on at least one trailer, the at least one trailer being coupled to the tractor;
receiving, at the computer system, road condition data from at least one sensor, the at least one sensor being located on at least one of the tractor and the at least one trailer;
identifying, via at least one processor of the computer system and based on the trailer sensor data and the road condition data, a physical condition of the at least one trailer to be modified; and
modifying, via an electrical signal transmitted from the computer system, the physical condition.

2. The method of claim 1, wherein the plurality of trailer sensors are mounted to the at least one trailer using at least one sensor rail, where each sensor rail can be removably coupled to the at least one trailer.

3. The method of claim 2, further comprising:
transmitting, from the computer system to a trailer sensor within the plurality of trailer sensors, a command to change location on a sensor rail within the at least one sensor rail.

4. The method of claim 2, wherein the at least one sensor rail is removably coupled to the at least one trailer in a vertical configuration, with a first end of the at least one sensor rail located directly above a second end of the at least one sensor rail.

5. The method of claim 2, wherein the at least one sensor rail is removably coupled to the at least one trailer in a horizontal configuration, with a first end of the at least one sensor rail located laterally to a second end of the at least one sensor rail.

6. The method of claim 1, wherein the modifying of the physical condition comprises at least one of:
applying brake pressure to at least one wheel supporting the at least one trailer;
modifying a steerable axle;
raising or lowering trailer suspension; and
adjusting ride height of an air bag on the at least one trailer.

7. The method of claim 1, wherein the tractor is configured to operate in both a manual mode and the autonomous mode.

8. The method of claim 1, wherein the receiving of the trailer sensor data, the receiving of the road condition data, the identifying of the physical condition, and the modifying of the physical condition occur while the tractor and the at least one trailer are in transit.

9. The method of claim 1, wherein the road conditions data indicates the at least one trailer will not clear an overpass without modifying trailer suspension of the at least one trailer.

10. The method of claim 1, wherein the road condition data comprises wind data for winds hitting the at least one trailer.

11. An articulated vehicle comprising:
a tractor operating in an autonomous mode;
at least one trailer coupled to the tractor;
at least one processor; and
a non-transitory computer-readable storage medium having instructions stored which, when executed by the at least one processor, cause the at least one processor to perform operations comprising:
receiving trailer sensor data from a plurality of trailer sensors located on the at least one trailer;
receiving road condition data from at least one sensor, the at least one sensor being located on at least one of the tractor and the at least one trailer;
identifying, based on the trailer sensor data and the road condition data, a physical condition of the at least one trailer to be modified; and
modifying, via a transmitted electrical signal, the physical condition.

12. The articulated vehicle of claim 11, wherein the plurality of trailer sensors are mounted to the at least one trailer using at least one sensor rail, where each sensor rail can be removably coupled to the at least one trailer.

13. The articulated vehicle of claim 12, the non-transitory computer-readable storage medium having additional instructions stored which, when executed by the at least one processor, cause the at least one processor to perform additional operations comprising:
transmitting, to a trailer sensor within the plurality of trailer sensors, a command to change location on a sensor rail within the at least one sensor rail.

14. The articulated vehicle of claim 12, wherein the at least one sensor rail is removably coupled to the at least one trailer in a vertical configuration, with a first end of the at least one sensor rail located directly above a second end of the at least one sensor rail.

15. The articulated vehicle of claim 12, wherein the at least one sensor rail is removably coupled to the at least one trailer in a horizontal configuration, with a first end of the at least one sensor rail located laterally to a second end of the at least one sensor rail.

16. The articulated vehicle of claim 11, wherein the modifying of the physical condition comprises at least one of:
applying brake pressure to at least one wheel supporting the at least one trailer;
modifying a steerable axle;
raising or lowering trailer suspension; and
adjusting ride height of an air bag on the at least one trailer.

17. The articulated vehicle of claim 11, wherein the tractor is configured to operate in both a manual mode and the autonomous mode.

18. The articulated vehicle of claim 11, wherein the receiving of the trailer sensor data, the receiving of the road condition data, the identifying of the physical condition, and the modifying of the physical condition occur while the tractor and the at least one trailer are in transit.

19. The articulated vehicle of claim 11, wherein the road conditions data indicates the at least one trailer will not clear an overpass without modifying trailer suspension of the at least one trailer.

20. The articulated vehicle of claim 11, wherein the road condition data comprises wind data for winds hitting the at least one trailer.
